(19) United States
(12) Patent Application Publication
(10) Pub. No.: US 2026/0218044 A1
(43) Pub. Date: Jul. 30, 2026

(54) BLUE LIGHT-EMITTING MATERIAL HAVING A PEROVSKITE-LIKE STRUCTURE AND IMPROVED PHOTOLUMINESCENT QUANTUM YIELD, AND METHOD OF PREPARING SAME

(71) Applicant: IUCF-HYU (IND-UNIV.COOPERATION FOUNDATION HANYANG UNIVERSITY), Seoul (KR)

(72) Inventors: Won Bin IM, Seoul (KR); Viswanath NOOLU SRINIVASA MANIKANTA, Seoul (KR); Joo Hyeong HAN, Seoul (KR)

(21) Appl. No.: 19/142,381

(22) PCT Filed: Dec. 22, 2023
(86) PCT No.: PCT/KR2023/021517

§ 371 Date: Jun. 23, 2025

(30) Foreign Application Priority Data
Dec. 23, 2022 (KR) 10-2022-0183665

(51) Int. Cl. C09K 11/77; C01F 17/36; C04B 35/515; C04B 35/553; C04B 35/626; C04B 35/64; C09K 11/02

(52) U.S. Cl. CPC C09K 11/7705; C01F 17/36; C04B 35/5156; C04B 35/553; C04B 35/6262; C04B 35/62675; C04B 35/64; C09K 11/02; C01P 2002/72; C01P 2002/77; C01P 2006/60; C04B 2235/401; C04B 2235/404; C04B 2235/445; C04B 2235/656; C04B 2235/9646

(57) ABSTRACT

A blue light-emitting material represented by Chemical Formula 1, which has an emission peak wavelength in a range of 380 nm to 500 nm, upon being excited by an excitation source of 250 nm to 400 nm, a half width at half maximum of the emission spectrum of less than 30 nm, a photoluminescent quantum yield (PLQY) of 80% or more, and an average luminescence lifetime of 80 nanoseconds or more, and a method of preparing the blue light-emitting material are provided:

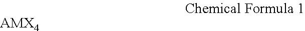

in Chemical Formula 1, A includes Li, Na, K, Rb, Cs, Mg, Ca, Sr, Ba, or a combination thereof, M includes Sc, Y, Al, Gd, Lu, or a combination thereof, and X includes O, F, Cl, Br, I, or a combination thereof.

### TECHNICAL FIELD

This relates to a blue light-emitting material having a perovskite-like structure and exhibiting excellent light-emitting efficiency, and a method of preparing the blue light-emitting material.

### BACKGROUND ART

Blue phosphor materials used in LEDs, etc. require properties such as high color purity and/or thermal stability. Examples of currently known blue phosphor materials include CaWO₄ phosphors emitting a wavelength of about 400 nm to about 420 nm, MgWO₄ phosphors emitting a wavelength of about 480 nm, etc., and Pb (lead) is used as an activator. In the case of these phosphors, since light is emitted from the activator doped in the host, there is a problem that they have a wide fluorescence spectrum (i.e., low color purity) and contain lead (Pb), which is harmful to the human body. Another example of a blue phosphor material is a BaMaAl₁₀O₁₇:Eu²⁺ phosphor that uses Eu²⁺ ion as an activator, but this also tends to contain a lot of light in green region, which leads to low color purity, and has low thermal stability that limits the lifespan of the phosphor.

Compounds having a perovskite structure with the structural formula AMX₃ (A is a cation, M is a metal cation, and X is an anion) are being used in various fields, such as, for example, a display, a light-emitting diode, a solar cell, a photodetector, a laser, and the like, due to their high quantum yield, large absorption coefficient, and tunable band gap characteristics. Although the perovskite structure shows excellent optical properties including high luminescence efficiency, it is necessary to overcome the toxicity of divalent cations such as Pb and Sb as metal cations.

### DISCLOSURE

### Technical Problem

An embodiment provides a novel blue luminescent material having high color purity, excellent thermal stability, and superior luminescent efficiency.

Another embodiment provides a method of preparing the novel blue light-emitting material.

### Technical Solution

An embodiment provides a blue light-emitting material represented by Chemical Formula 1, the blue light-emitting material has an emission peak wavelength in a range of 380 nanometers (nm) to 500 nm, upon being excited by an excitation source having a wavelength range of 250 nm to 400 nm, a full width at half maximum (FWHM) of the emission peak wavelength of less than 30 nm, a photoluminescent quantum yield (PLQY) of 80% or more, and an average luminescence lifetime of 80 nanoseconds or more:

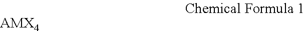

in Chemical Formula 1,
A includes Li, Na, K, Rb, Cs, Mg, Ca, Sr, Ba, or a combination thereof,
M includes Sc, Y, Al, Gd, Lu, or a combination thereof, and
X includes O, F, Cl, Br, I, or a combination thereof.

In Chemical Formula 1,
A includes Rb, Cs, Sr, Ba, or a combination thereof,
M includes Sc, Y, Al, or a combination thereof, and
X includes F, Cl, Br, or a combination thereof.

Chemical Formula 1 may be represented by Chemical Formula 2 or Chemical Formula 3:

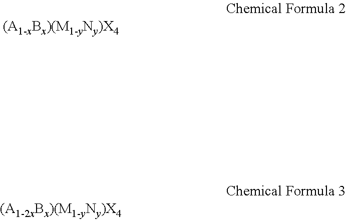

in Chemical Formula 2 and Chemical Formula 3,
A includes Rb,
B includes Li, Na, K, Cs, Mg, Ca, Sr, Ba, or a combination thereof,
M includes Sc,
N includes Y, Al, Gd, Lu, or a combination thereof,
X includes O, F, Cl, Br, I, or a combination thereof, and
x is 0.01≤x≤0.10, and y is 0.01≤y≤0.10.

In Chemical Formula 2 and Chemical Formula 3, B may include Cs.

In Chemical Formula 2 and Chemical Formula 3, X may include F, and at least one of O, Cl, Br, of I.

In Chemical Formula 2 and Chemical Formula 3, X may include F and O.

The blue light-emitting material represented by the Chemical Formula 1 has an orthorhombic structure of Cmcm, and diffraction angles (2θ) of a first intensity peak and a second intensity peak, which is lower than the first intensity peak, in a range of 20526530, in an X-ray diffraction pattern.

The blue light-emitting material represented by Chemical Formula 1 has a diffraction angle (2θ) of the first intensity peak in a range of 26.2526528.2, and a diffraction angle (2θ) of the second intensity peak in a range of 25.8526527.8, in the X-ray diffraction pattern.

The blue light-emitting material represented by Chemical Formula 1 may be represented by RbScF₄.

Another embodiment provides a method of preparing a blue light-emitting material, the method includes:
mixing a halide of Li, Na, K, Rb, Cs, Mg, Ca, Sr, Ba, or a combination thereof, and a halide of Sc, Y, Al, Gd, Lu, or a combination thereof to form a mixture;
heating the mixture at a temperature of from 500° C. to 600° C. under a strongly reducing atmosphere to form a heated material; and
sintering the heated material at a temperature of from 600° C. to 700° C. under a strongly reducing atmosphere to form a sintered material.

The heating the mixture under a strongly reducing atmosphere includes heating the mixture together with magnesium powder, titanium powder, or a combination thereof.

The method further includes pulverizing the mixture prior to the heating.

The method further includes pulverizing the heated material prior to the sintering.

The method further includes pulverizing the sintered material.

The method further includes pulverizing the mixture prior to the heating, pulverizing the heated material prior to the sintering, and pulverizing the sintered material after the sintering.

Still another embodiment provides a blue light-emitting material represented by Chemical Formula 1, the blue light-emitting material is prepared by mixing a halide of Li, Na, K, Rb, Cs, Mg, Ca, Sr, Ba, or a combination thereof, and a halide of Sc, Y, Al, Gd, Lu, or a combination thereof to form a mixture; heating the mixture together with magnesium powder, titanium powder, or a combination thereof to form a heated material; and sintering the heated material at a temperature higher than that of the heating to form a sintered material; wherein the blue light-emitting material has an emission peak wavelength in a range of 380 nm to 500 nm, upon being excited by an excitation source having a wavelength range of 250 nm to 400 nm, a full width at half maximum of the emission peak wavelength of less than 30 nm, a photoluminescent quantum yield (PLQY) of 80% or more, and an average luminescence lifetime of 80 nanoseconds or more:

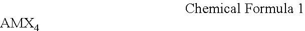

in Chemical Formula 1,
A includes Li, Na, K, Rb, Cs, Mg, Ca, Sr, Ba, or a combination thereof,
M includes Sc, Y, Al, Gd, Lu, or a combination thereof, and
X includes O, F, Cl, Br, I, or a combination thereof.

The blue light-emitting material may be represented by RbScF₄.

### Advantageous Effects

The blue light-emitting material according to an embodiment is a lead-free blue light-emitting phosphor, which has a superior quantum efficiency (PLOY), a narrow full width at half maximum of an emission peak wavelength, excellent thermal and chemical stability, and a long luminescence lifetime compared to conventional lead-free blue light-emitting phosphors. Therefore, the blue light-emitting material according to an embodiment can be advantageously applied to various light-emitting devices, such as, for example, light-emitting diodes (LEDs), solar cells, photovoltaics, sensors, color filters, and the like, without environmental issues.

### DESCRIPTION OF DRAWING

FIG. 1 shows X-ray diffraction patterns of RbScF₄ prepared under a strong reduction condition (SRC), in a mild reduction condition (MRC), and an inert atmosphere (IC), respectively.

FIG. 2 shows graphs of photoluminescence intensities versus wavelengths of RbScF₄ prepared under a strong reduction condition (SRC), in a mild reduction condition (MRC), and an inert atmosphere (IC), respectively.

FIG. 3 shows graphs of absorbances versus band gap energies of RbScF₄ prepared under a strong reduction condition (SRC), and in a mild reduction condition (MRC), respectively.

FIG. 4 shows structural models of RbScF₄ used for calculations according to density functional theory (DFT), in which (a) shows RbScF₄ unit cell optimized with the Perdew-Burke-Ernzerhof (PBE) functional, and (b) shows the extended 3×1×2 supercell model used for electronic structure calculations.

FIG. 5 shows schematic crystal structures of a supercell model (a) of RbScF₄ shown in FIG. 4(b), a supercell model (b) of RbScF₄ having one F vacancy in model (a) (RbScF₄-1V), and a supercell model (c) of RbScF₄ having two F vacancies (RbScF₄-2V) in model (a).

FIG. 6 shows graphs showing electronic structures of each model of FIG. 5, in which the electronic structures were estimated with conventional Heyd-Scuseria-Ernzerhof (HSE) 06 functional (α=0.25).

FIG. 7 shows graphs of density of states versus band gap energies of each model of FIG. 5, which show the effects of F vacancy in the models.

FIG. 8 shows graphs showing changes in luminescence intensities (PL intensities) at 420 nm of emission wavelength of RbScF₄ prepared under a strong reduction condition (SRC), in a mild reduction condition (MRC), and an inert atmosphere (IC), respectively, over time.

FIG. 9 shows graphs of thermoluminescence (TL) intensities versus temperature of RbScF₄ prepared under a strong reduction condition (SRC), in a mild reduction condition (MRC), and an inert atmosphere (IC).

### BEST MODE

Lead-free (Pb-free) perovskite materials have been known to have low quantum yields (PLQY) due to their low absorption coefficients. In addition, the device characteristics using the lead-free perovskite materials are very low compared to those of lead-based materials. The performance, stability, and efficiency of the lead-free perovskite materials are still lower due to their low PLQY values than lead-based perovskite materials. Therefore, there is a need to improve the quantum efficiency of the lead-free perovskite materials.

Recent studies have shown that the lead-free perovskite materials, such as Cs₃CuI₅, (C₉NH₂₀)₂SnBr₄, etc., have excellent luminescence properties, such as, for example, high photoluminescence quantum yields (PLQY) of 90% and 46%, respectively, and high exciton binding energies (E_{b}), compared to lead-based perovskites, such as, for example, CsPbX₃. However, the oxidation of Sn²⁺ or Cu⁺ ions in air, and the instability of organic components to moisture and heat limit the practical applications of the materials, and there are still remaining issues to be improved.

The inventors of the present application have developed a novel blue light-emitting material, which is a lead-free layered perovskite-like material, having an emission peak wavelength in a wavelength range of 380 nm to 500 nm, upon being excited by an excitation source having a wavelength range of 250 nm to 400 nm, a full width at half maximum of the emission peak wavelength of less than 30 nm, a quantum efficiency of 80% or more, and an average luminescence lifetime of 80 nanoseconds or more, thereby completing the present invention. The blue light-emitting material may be represented by Chemical Formula 1:

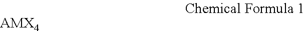

in Chemical Formula 1,
A includes Li, Na, K, Rb, Cs, Mg, Ca, Sr, Ba, or a combination thereof,
M includes Sc, Y, Al, Gd, Lu, or a combination thereof, and
X includes O, F, Cl, Br, I, or a combination thereof.

In Chemical Formula 1, A may include Rb, Cs, Sr, Ba, or a combination thereof, M may include Sc, Y, Al, or a combination thereof, and X may include F, Cl, Br, or a combination thereof.

The blue light-emitting material represented by Chemical Formula 1 may be represented by Chemical Formula 2 or Chemical Formula 3:

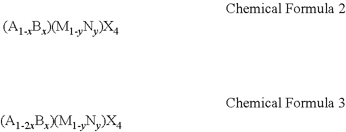

in Chemical Formula 2 and Chemical Formula 3,
A may include Rb,
B may include Li, Na, K, Cs, Mg, Ca, Sr, Ba, or a combination thereof,
M may include Sc,
N may include Y, Al, Gd, Lu, or a combination thereof,
X may include O, F, Cl, Br, I, or a combination thereof, and
x may be 0.01≤x≤0.10, and y may be 0.01≤y≤0.10.

In Chemical Formula 2 and Chemical Formula 3, B may include Cs, and X may include F, and one or more of O, Cl, Br, and I, for example, X may include F and O.

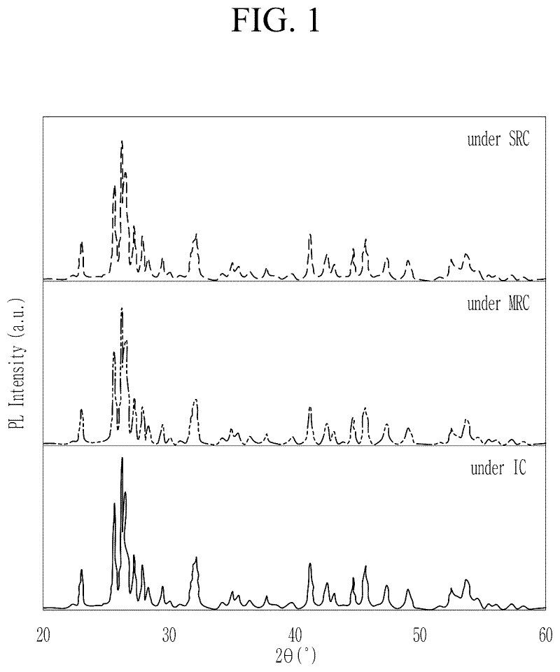

The blue light-emitting material represented by Chemical Formula 1 has an orthorhombic structure of Cmcm, and as can be seen from the X-ray diffraction patterns of FIG. 1, the diffraction angles (2θ) of the first intensity peak and the second intensity peak, which is lower than the first intensity peak, may be positioned in a range of 20≤2θ≤30. For example, the blue light-emitting material represented by Chemical Formula 1 may have the first intensity peak positioned in a diffraction angle (2θ) of 26.2≤2θ≤28.2, and the second intensity peak positioned in a diffraction angle (2θ) of 25.8≤2θ≤27.8, in the X-ray diffraction pattern.

As can be seen from FIG. 1, the X-ray diffraction patterns of the blue emitting materials represented by Chemical Formula 1 basically have the same diffraction angle (2θ) patterns even when they are synthesized under different reducing conditions, as long as the types of A, M, and X of Chemical Formula 1 are the same. That is, even when synthesized under different reducing conditions, as long as A, M, and X are the same, the blue light-emitting material represented by Chemical Formula 1 has the same basic crystal structure.

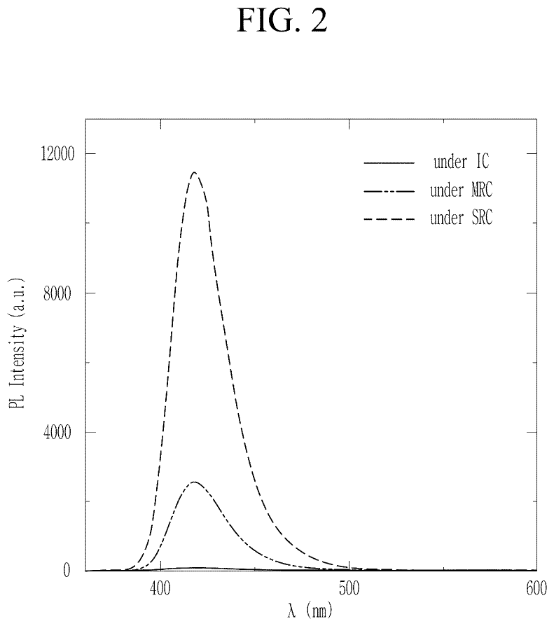

However, as can be seen from FIG. 2, the blue light-emitting materials represented by Chemical Formula 1 may exhibit different luminescence intensities depending on the reduction conditions. That is, when prepared in an inert atmosphere (IC: Inert Condition), such as, for example, Ar gas, the prepared material may exhibit little or very low luminescence. However, when prepared in a mild (or weak) reducing gas atmosphere (MRC: Mild Reduction Condition) that contains a mixture of hydrogen and nitrogen gases, the material exhibits a low luminescence intensity. In addition, it can be seen that the material represented by Chemical Formula 1 exhibits a strong luminescence intensity when prepared in a strong reducing atmosphere (SRC: Strong Reduction Condition). That is, the inventors of the present application have discovered that the material represented by Chemical Formula 1, which exhibits very weak luminescence characteristics when prepared in an inert atmosphere, can exhibit relatively strong luminescence characteristics by being prepared in a reducing atmosphere, and further, can be prepared into a blue light-emitting material that exhibits very strong luminescence characteristics by being prepared in a strong reducing atmosphere (SRC), thereby completing the present invention.

In this regard, KR Patent Application No. 10-2020-0177270 (filed on Dec. 17, 2020, KR Patent Laid-open Publication No. 2022-0086985A1, published on Jun. 24, 2022) belonging to the inventors of the present application discloses that in the first heat treating step, a reducing atmosphere was not applied, but in the sintering step, a mixed gas of hydrogen and nitrogen was used to prepare a blue light-emitting material represented by Chemical Formula 1, thereby producing a blue light-emitting material having a quantum efficiency (PQLY) of about 80%. The entirety of the patent application is incorporated herein by reference. The patent application discloses a blue light-emitting material exhibiting similar luminescence characteristics to those of the present application by sintering the final material using a mixed gas containing hydrogen in an amount of about 5% to 30%. However, as described later, the method according to an embodiment of the present application includes performing heat treatment under a strong reducing atmosphere (SRC), i.e., not only in the final sintering step, but also in the previous heat treatment step, and further sintering under a strong reducing atmosphere (SRC) in the subsequent sintering step, thereby obtaining a new blue light-emitting material having much stronger luminescence characteristics and a longer luminescence lifetime than the blue light-emitting material disclosed in KR Patent Application No. 2020-0177270. The fact that the luminescence characteristics of the material represented by Chemical Formula 1 can be controlled by controlling the reducing atmosphere was not known and is a surprising result that was not expected from KR Patent Application No. 2020-0177270.

In an embodiment, the blue light-emitting material represented by Chemical Formula 1 may be represented by RbScF₄. RbScF₄ as prepared in an example described later has a peak emission wavelength of about 420 nm, a PLQY of 80% or more, a full width at half maximum (FWHM) of the peak emission wavelength of about 25 nm, and an average luminescence lifetime of 80 ns or more, thereby having high stability and excellent luminescence characteristics. The blue light-emitting material represented by Chemical Formula 1 prepared in KR Patent Application No. 2020-0177270, for example, RbScF₄, has a PLQY similar to that of the material represented by Chemical Formula 1 of the present invention, but has a lower luminescence lifetime, and further, as shown in FIG. 2, has much lower luminescence intensity (PL intensity) than that prepared in the present application. Therefore, the blue light-emitting material represented by Chemical Formula 1 of the present application is distinguished from the blue light-emitting material disclosed in KR Patent Application No. 2020-0177270, and can be recognized as a new material itself with improved performance.

Here, the “luminescence lifetime” means the time that a luminescent material spends in an excited state after being excited, emitting a photon, and returning to the ground state. The luminescence lifetime of a photon shows an exponential decrease distribution through energy loss due to luminescence or non-luminescence, and the time until it shows a luminescence intensity of about 36.8% of the initial luminescence intensity may be defined as an average luminescence lifetime. The luminescence lifetime can be measured by irradiating the luminescent material with a short-wavelength pulse laser as an excitation source in a time-resolved fluorescence spectrometer.

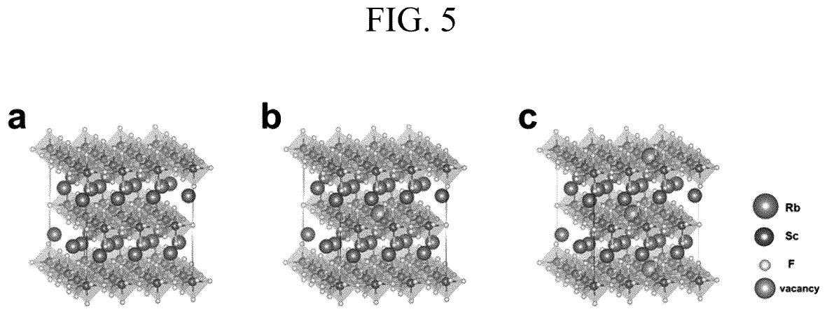

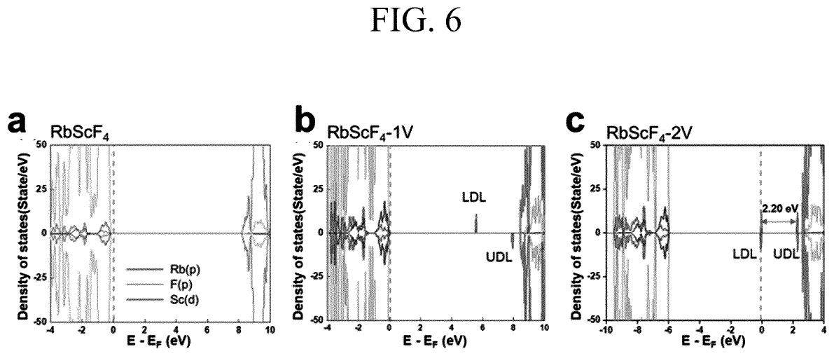

In order to elucidate the luminescence mechanism of the blue light-emitting material according to an embodiment, the inventors of the present invention performed calculations based on the density functional theory (DFT). In general, materials that emit light due to defects (defect-assisted luminescence materials) exhibit a wide luminescence band. Therefore, the blue luminescent material according to an embodiment also obtained a very wide band gap value exceeding 8.0 eV as a result of the DFT calculation. However, RbScF₄ actually prepared in the example of the present application has a very narrow full width at half maximum (FWHM) of about 25 nm and exhibits a high PLQY, which are very unique luminescence properties among existing luminescent materials. Surprisingly, RbScF₄ according to an embodiment exhibits a narrow luminescence band in the blue light region due to defects in the crystal structure in the bulk state, which confirms that the F defect or vacancy in RbScF₄ forms a defect level within the RbScF₄ band, thereby becoming an important factor in blue luminescence. In addition, as can be seen from FIGS. 5 and 6, it has been confirmed that the width (ΔE) of the defect levels and the band gap energy change depending on the F defect concentration in the crystal structure of the material. That is, the sharp and localized lower defect level (LDL: Lower Defect Level) and upper defect level (UDL: Upper Defect Level) of RbScF₄ provide theoretical considerations for the narrow FWHM of RbScF₄ observed experimentally. While not wishing to be bound by a particular theory, it is thought that pairs of localized defect levels participate in the photoluminescence sequence to narrow the FWHM and increase the PLQY of the blue light-emitting material.

Specifically, the fluorine (F) defect introduced into RbScF₄ generates a pair of sharply localized defect levels above the Fermi level (EF). Interestingly, the second fluorine defect rearranges the defect levels, bringing the LDL close to the Fermi level (EF) and the UDL just below the conduction band edge. Accordingly, the energy gap between the occupied LDL and the empty UDL becomes 2.20 eV, which is lower than the experimental value of 3.05 eV. This is an unusual phenomenon that has not been observed in the existing luminescent material library. Furthermore, the blue luminescent material according to an embodiment can also enhance the PLQY value by increasing the defect concentration by changing the atmospheric conditions.

Meanwhile, the blue light-emitting material according to an embodiment may be prepared by mixing a halide of Li, Na, K, Rb, Cs, Mg, Ca, Sr, Ba, or a combination thereof, and a halide of Sc, Y, Al, Gd, Lu, or a combination thereof to form a mixture; heating the mixture at a temperature of from about 500° C. to about 600° C. for a predetermined time under a strongly reducing atmosphere (SRC) to form a heated material; and sintering the heated material at a temperature of greater than 600° C. and less than or equal to about 700° C. under a strongly reducing atmosphere to form a sintered material. The heating the mixture under a strongly reducing atmosphere (SRC) may include heating the mixture together with magnesium powder, titanium powder, or a combination thereof, and the same strongly reducing atmosphere may be applied during the sintering process after the heating the mixture.

As described above, the blue light-emitting material according to an embodiment can exhibit excellent luminescence characteristics by being prepared under a strongly reducing atmosphere (SRC). For example, the blue light-emitting material may be prepared through a solid-state synthesis method. Here, the “solid-state synthesis method” means that precursor materials for preparing the material represented by Chemical Formula 1 may be mixed in stoichiometric amounts and reacted, but the reaction does not occur in a solution state but in a solid state. Specifically, the precursor materials may be weighed in stoichiometric amounts and mixed in a solid state without adding any solvent to the reaction materials. However, only a small amount of liquid medium may be added for uniform mixing, the solvent used for the mixing may be removed, and a heat treatment and sintering process may be performed to prepare the material.

As a solvent that may be used for the mixing, acetone, alcohol, distilled water, or a mixture thereof may be used, and as an example, acetone may be used. The mixture including the solvent may be put into a mixer, such as, for example, a ball mill or an agate mortar, mixed uniformly, and then the solvent may be removed therefrom. Then, the mixture may be heat-treated and sintered. The solvent may be mixed in an amount of about 100 parts by weight to about 400 parts by weight based on 100 parts by weight of the mixture, but is not limited thereto. When the amount of the solvent is less than 100 parts by weight, uniform mixing may be difficult, and when the amount of the solvent is more than 400 parts by weight, it may take too long to remove the solvent after the mixing.

After the mixing is completed, the solvent may be evaporated and removed, the dried mixture may be pulverized using agate mortar, etc., and then heat-treated at a high temperature in a strongly reducing atmosphere. The strongly reducing atmosphere may be provided by putting the mixture in an alumina crucible, etc., and then heating the mixture in a muffle furnace, and the like, along with metal powders, such as, for example, magnesium powder or titanium powder, and heating them together at a high temperature. The heat treatment may be performed at a temperature of from about 500° C. to about 600° C., for about from 4 hours to about 6 hours, or for example, about 5 hours.

After completion of the heat treatment, the heated material is naturally cooled, pulverized again using an agate mortar, and the pulverized material may be placed in a tubular furnace and sintered in a strongly reducing atmosphere again at a temperature higher than that of the previous heat treatment, for example, at a temperature of greater than 600° C. and less than or equal to about 700° C., for about from 5 hours to about 7 hours, or for example, about 6 hours. After the sintering is completed, the sintered material is cooled, and pulverized again using an agate mortar to be a blue light-emitting material according to an embodiment.

The blue light-emitting material according to an embodiment as prepared may have a defect or vacancy of an element represented by X in Chemical Formula 1, i.e., for example, fluorine (F), etc., may escape from the layered structure of the material represented by Chemical Formula 1 due to the strongly reducing atmosphere described above. The material represented by Chemical Formula 1 and including the defect may have excellent blue light-emitting characteristics, unlike a material that does not include the defect. As can be seen from the examples described later, the luminescence characteristics, for example, luminescence intensity, luminescence lifetime, etc., of the blue light-emitting material may also be controlled by controlling the strongly reducing atmosphere.

Meanwhile, the heat treatment temperature and/or time described above may affect the crystal structure, crystal size, crystallinity, or luminescence efficiency of the prepared blue light-emitting material. For example, if the heat treatment temperature is 500° C. or lower, it is difficult to form crystals, and if the heat treatment temperature is too high (for example, greater than 700° C.), it may be difficult to form crystals from the reactants, crystallinity may be reduced, or agglomeration of crystals may occur, thereby lowering yield and luminescence efficiency of the luminescent material. Therefore, the heat treatment and sintering temperature described above may be performed at an appropriate temperature and time.

Hereinafter, the embodiments are illustrated in more detail with reference to examples. However, they are exemplary examples of the present invention, and the present invention is not limited thereto. The scope of the present invention can be determined by the claims attached to the specification of the application.

### MODE FOR INVENTION

### Example

### Synthesis Example: Synthesis of Blue Light-Emitting Material RbScF₄

As commercially available starting materials, RbF (Sigma-Aldrich, 99.9%) and ScF₃ (Kojundo, 99.9%) were used without further purification. RbScF₄, a lead-free layered perovskite-like material, was synthesized through the following process.

Specifically, the above two starting materials are stoichiometrically weighed, uniformly mixed with a small amount of acetone in an agate mortar for about 30 minutes, and then dried. For example, about 0.25004 g (1 mol) of RbF and about 1 g of ScF₃ are used per 1 mol of RbScF₄. The obtained powder is placed in an alumina crucible, put in a muffle furnace in which titanium powder and magnesium powder are placed, and heated at a temperature of about 550° C., for about 5 hours. The amounts of the titanium powder and the magnesium powder were 1 g each per 1 mol of RbScF₄. After the heat treatment, the obtained powder was pulverized using an agate mortar, placed in a tubular furnace, and then placed in the muffle furnace where the titanium powder and magnesium powder were placed and sintered by heating at a temperature of about 650° C., for about 6 hours. After sintering is complete, the obtained powder is cooled to room temperature, and then pulverized again using an agate mortar into fine particles having a particle size of about from 30 micrometers to 50 micrometers. The obtained blue light-emitting particles are referred to as a blue light-emitting material according to an example prepared in a strongly reducing atmosphere (SRC).

Meanwhile, as a reference, a blue light-emitting material was prepared in the same manner as described above, except that the heat treatment and the sintering were performed in an inert atmosphere (IC) using argon gas instead of a reducing atmosphere.

In addition, as a comparative example, a blue light-emitting material was prepared in the same manner as described above, except that the heat treatment and the sintering were performed in a weak reducing atmosphere (MRC) using a mixture of hydrogen and nitrogen gases as a reducing atmosphere, in which the amount of hydrogen gas was 25%.

### Evaluation

### (1) Measurement of X-Ray Diffraction Pattern and Luminescence Intensity

X-ray diffraction patterns and luminescence intensities of each of the blue light-emitting materials according to an example, a reference, and a comparative example were measured, and the results are shown in FIG. 1 and FIG. 2, respectively.

From FIG. 1, it can be seen that the X-ray diffraction patterns of each material according to an example (SRC), a reference (IC), and a comparative example (MRC) are all identical. That is, even if different atmospheric conditions are applied during the heat treatment and sintering processes, it can be confirmed that the atmospheric conditions do not change the crystal structure of the materials themselves, and the original crystal structure of the materials is maintained even when the atmospheric conditions are changed.

On the other hand, as can be seen from FIG. 2, the atmospheric conditions during the heat treatment and sintering processes changed the luminescence characteristics of each material. Specifically, the reference material prepared in an inert atmosphere (IC) hardly exhibited luminescence characteristics, whereas the material according to the comparative example prepared in a weak reducing atmosphere (MRC) of which a content of hydrogen gas is 25% exhibited luminescence characteristics, although lower than the material according to the embodiment. In the case of the example, by using a strongly reducing atmosphere (SRC), the luminescence intensity of the material according to an example (SRC) is about 4 times higher than that of the comparative example (MRC). That is, while the crystal structure of the materials is not changed by the atmospheric conditions, the luminescence characteristics of the materials can be changed by controlling the concentration of defects (or traps) in the crystal structure.

### (2) Measurement of Light Absorption Characteristics and Changes in Energy Band Gap

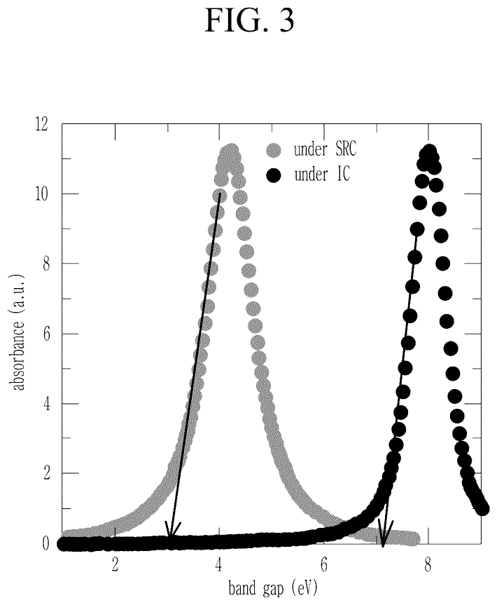

The light absorption characteristics of the reference material prepared in an inert atmosphere (IC) and the material according to the example prepared in a strongly reducing atmosphere (SRC) were measured from the results of FIG. 2, and the energy band gaps were measured accordingly and shown in FIG. 3.

As shown in FIG. 3, the reference RbScF₄ prepared in an inert atmosphere (IC) exhibits a very high band gap energy of 7.2 eV, which cannot explain the blue luminescence observed at around 420 nm. On the other hand, the example RbScF₄ prepared in a strongly reducing atmosphere (SRC) exhibits a significantly reduced band gap energy of 2.92 eV, which exactly matches the energy associated with blue luminescence. Consequently, the energy change according to the defect state of each material can be confirmed from the experimentally observed band gap energy.

### (3) Interpretation of Changes in Luminescence Characteristics Due to F Defect Caused by Control of Reducing Atmosphere

As can be seen from FIGS. 1 and 2, the materials according to the reference, comparative example, and example show no change in X-ray diffraction patterns, but exhibit different luminescence intensities. From this, it can be seen that the increase in luminescence intensity of the blue light-emitting material according to the example is due to a change in a specific element in the material due to the control of the reducing atmosphere.

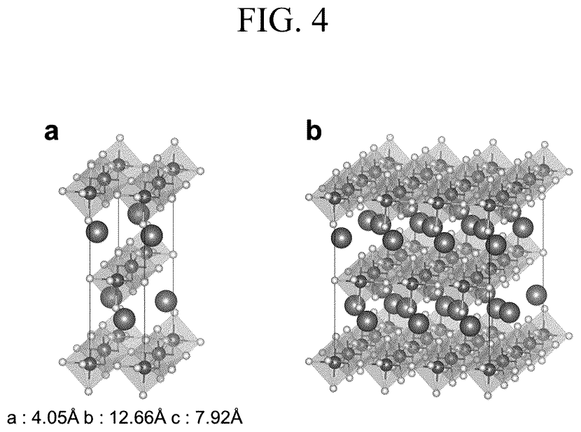

In this regard, in order to explain the factors causing the change in the luminescence intensity, calculations were performed according to the density functional theory (DFT). FIG. 4 is a structural model of RbScF₄ used for the calculations of the density functional theory, where (a) shows the RbScF₄ unit cell optimized with the Perdew-Burke-Ernzerhof (PBE) functional, and (b) shows the extended 3×1×2 supercell model used for the calculations of the electronic structure.

Also, FIG. 5 shows the schematic crystal structures of the supercell model (a) of RbScF₄ shown in FIG. 4(b), the model (b) of RbScF₄ having one F vacancy in the model (a) (RbScF₄-1V), and the model (c) of RbScF₄ having two F vacancies in the model (a) (RbScF₄-2V). All models were initially optimized with PBE functional, and used for further electronic structure calculations. The most stable defect location was identified by comparing the total energies of supercells with F defects at different locations.

FIG. 6 shows graphs of electronic structures estimated by the conventional Heyd-Scuseria-Ernzerhof (HSE) 06 functional (α=0.25) for each model of FIG. 5.

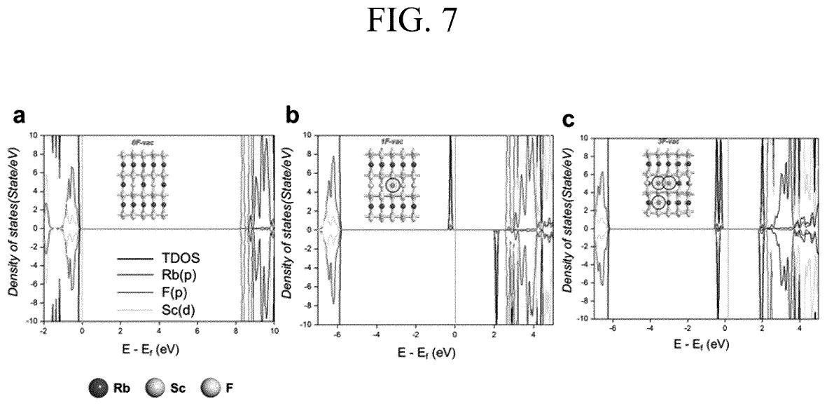

FIG. 7 shows schematic diagrams showing the effect on the density of states and band gap energy according to the F defect for each model of FIG. 5.

The electronic structures and density of states (DOS) of RbScF₄ were simulated based on spin-polarized density functional theory (DFT) calculations. The electronic structure and DOS of RbScF₄ were defined based on the 2X1X2 and 3X1X2 slab models of Rb₂₄Sc₂₄F₉₆, which are shown in (a) and (b) in FIG. 4. The band gap energy of defect-free RbScF₄ is estimated to be greater than 10 eV from the simulation results (see (a) in FIG. 5 and (a) in FIG. 6). The charges at the conduction band (CB) edge are mainly composed of Sc(d) orbitals, whereas those at the valence band (VB) edge are mainly composed of F(p) orbitals. However, this result cannot explain the origin of the blue luminescence of RbScF₄ with a wide band gap energy of up to 10 eV.

F vacancy defects were created in RbScF₄, as shown in (b) of FIG. 5, and the band structure and DOS of RbScF₄ in which the F vacancies are created are simulated and illustrated in (b) of FIG. 6 and (b) of FIG. 7, respectively. As can be seen in (b) of FIG. 6 and (b) of FIG. 7, a defect pair above the Fermi level (EF) is created after the F vacancy is introduced into RbScF₄. In addition, as shown in (c) of FIG. 6 and (c) of FIG. 7, the defect levels are rearranged such that the lower defect level (LDL) moves exactly to EF and the upper defect level (UDL) moves just below the conduction band edge as the F vacancy is additionally introduced in (c) of FIG. 5.

In addition, the gap between the occupied LDL and empty UDL in (c) of FIG. 6 and (c) of FIG. 7 is found to be 2.92 eV, which is almost consistent with the experimental band gap energy value of 2.95 eV of RbScF₄ prepared under SRC shown in FIG. 3. That is, the energy difference between the corresponding defect states is consistent with the blue luminescence energy of RbScF₄, thus supporting that the sharp and localized LDL and UDL shown in (c) of FIG. 7 are the origin of the blue luminescence.

### (4) Measurement and Evaluation of Average Luminescence Lifetime

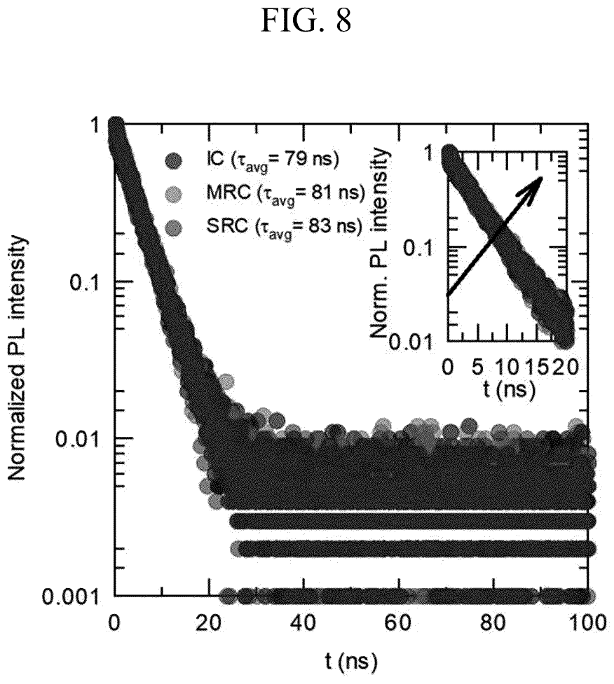

FIG. 8 is a graph showing changes in luminescence intensities (PL intensity) at 420 nm emission wavelength of RbScF₄ materials prepared in each of the example, comparative example, and reference over time. From the graphs, the average luminescence lifetimes of the materials prepared under each atmospheric condition can be compared. Since the photoluminescence lifetime of a material is proportional to its luminescence efficiency, the graphs of FIG. 8 support the luminescence efficiencies of the materials prepared under each synthetic atmosphere.

From FIG. 8, it can be seen that the average luminescence lifetime of RbScF₄ according to the example prepared in a strongly reducing atmosphere (SRC) is further extended compared to that of RbScF₄ according to the comparative example prepared in a weakly reducing atmosphere (MRC).

### (5) Evaluation of Thermal Luminescence (TL) Intensity

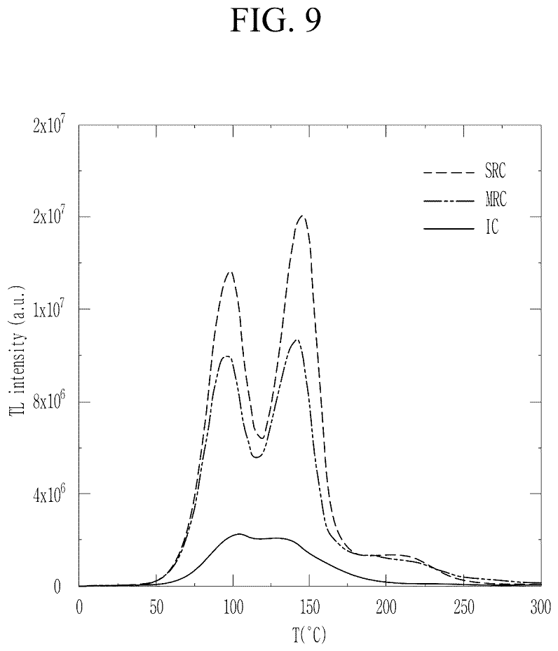

FIG. 9 shows thermoluminescence (TL) spectrographs for RbScF₄ materials prepared under a strongly reducing atmosphere (SRC), a weakly reducing atmosphere (MRC), and an inert atmosphere (IC), respectively.

RbScF₄ materials prepared under SRC and MRC, respectively, exhibit two distinct peaks in each graph. These peaks represent the level of F defects within the layered structure of each material, and by comparing the areas of each peak, it can be confirmed that RbScF₄ prepared under SRC has the highest trap density. In addition, RbScF₄ prepared under IC exhibits very low peaks, indicating that almost no F defects occurred within the layered structure.

From these TL strength evaluation results, the correlation between the luminescence characteristics and defects in RbScF₄ prepared under each atmospheric condition can be supported.

Although the present invention has been described by way of example only and in accordance with the embodiments, the scope of the present invention is not limited thereto, and those skilled in the art will understand that various modifications and variations are possible without departing from the essential characteristics of the present invention. Accordingly, the embodiments of the present specification described above may be implemented separately or in combination, and the protection scope of the present invention should be interpreted by the claims attached, and all technical ideas within a scope equivalent thereto should be interpreted as being included in the scope of the rights of the present invention.

1. A blue light-emitting material represented by Chemical Formula 1,
wherein the blue light-emitting material having an emission peak wavelength in a range of 380 nanometers to 500 nanometers, upon being excited by an excitation source having a wavelength range of 250 nanometers to 400 nanometers, a full width at half maximum of the emission peak wavelength of less than 30 nm, a photoluminescent quantum yield (PLQY) of 80% or more, and an average luminescence lifetime of 80 nanoseconds or more: 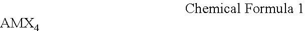
wherein, in Chemical Formula 1,
A comprises Li, Na, K, Rb, Cs, Mg, Ca, Sr, Ba, or a combination thereof,
M comprises Sc, Y, Al, Gd, Lu, or a combination thereof, and
X comprises O, F, Cl, Br, I, or a combination thereof.

2. The blue light-emitting material according to claim 1,
wherein, in Chemical Formula 1,
A comprises Rb, Cs, Sr, Ba, or a combination thereof,
M comprises Sc, Y, Al, or a combination thereof, and
X comprises F, Cl, Br, or a combination thereof.

3. The blue light-emitting material according to claim 1,
wherein Chemical Formula 1 is represented by Chemical Formula 2 or Chemical Formula 3: 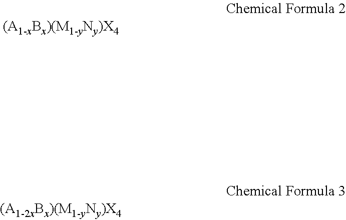
wherein, in Chemical Formula 2 and Chemical Formula 3,
A comprises Rb,
B comprises Li, Na, K, Cs, Mg, Ca, Sr, Ba, or a combination thereof,
M comprises Sc,
N comprises Y, Al, Gd, Lu, or a combination thereof,
X comprises O, F, Cl, Br, I, or a combination thereof, and
x is 0.01≤x≤0.10, and y is 0.01≤y≤0.10.

4. The blue light-emitting material according to claim 1,
wherein, in Chemical Formula 2 and Chemical Formula 3,
B comprises Cs.

5. The blue light-emitting material according to claim 1,
wherein, in Chemical Formula 2 and Chemical Formula 3,
X comprises F, and at least one of O, Cl, Br, and I.

6. The blue light-emitting material according to claim 1,
wherein, in Chemical Formula 2 and Chemical Formula 3,
X comprises F and O.

7. The blue light-emitting material according to claim 1, wherein the blue light-emitting material has an orthorhombic structure of Cmcm, and diffraction angles (2θ) of a first intensity peak and a second intensity peak, which is lower than the first intensity peak, in a range of 20≤2θ≤30, in an X-ray diffraction pattern.

8. The blue light-emitting material according to claim 1, wherein the blue light-emitting material has a diffraction angle (2θ) of a first intensity peak in a range of 26.2≤2θ≤28.2, and a diffraction angle (2θ) of a second intensity peak in a range of 25.8≤2θ≤27.8, in an X-ray diffraction pattern.

9. The blue light-emitting material according to claim 1, wherein the blue light-emitting material is represented by RbScF₄.

10. A method of preparing a blue light-emitting material, the method comprising:
mixing a halide of Li, Na, K, Rb, Cs, Mg, Ca, Sr, Ba, or a combination thereof, and a halide of Sc, Y, Al, Gd, Lu, or a combination thereof to form a mixture;
heating the mixture at a temperature of from 500° C. to 600° C. under a strongly reducing atmosphere to form a heated material; and
sintering the heated material at a temperature of from 600° C. to 700° C. under a strongly reducing atmosphere to form a sintered material.

11. The method according to claim 10, wherein the heating the mixture under a strongly reducing atmosphere comprises heating the mixture together with magnesium powder, titanium powder, or a combination thereof.

12. The method according to claim 10, wherein the method further comprises pulverizing the mixture prior to the heating.

13. The method according to claim 10, wherein the method further comprises pulverizing the heated material prior to the sintering.

14. The method according to claim 10, wherein the method further comprises pulverizing the sintered material.

15. The method according to claim 10, wherein the method further comprises pulverizing the mixture prior to the heating, pulverizing the heated material prior to the sintering, and pulverizing the sintered material after the sintering.

16. A blue light-emitting material represented by Chemical Formula 1,
wherein the blue light-emitting material is prepared by mixing a halide of Li, Na, K, Rb, Cs, Mg, Ca, Sr, Ba, or a combination thereof, and a halide of Sc, Y, Al, Gd, Lu, or a combination thereof to form a mixture; heating the mixture together with magnesium powder, titanium powder, or a combination thereof to form a heated material; and sintering the heated material at a temperature higher than that of the heating, and
wherein the blue light-emitting material has an emission peak wavelength of 380 nanometers to 500 nanometers, upon being excited by an excitation source having a wavelength range of 250 nanometers to 400 nanometers, a full width at half maximum of the emission peak wavelength of less than 30 nm, a photoluminescent quantum yield (PLQY) of 80% or more, and an average luminescence lifetime of 80 nanoseconds or more: 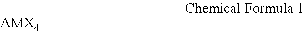
wherein in Chemical Formula 1,
A comprises Li, Na, K, Rb, Cs, Mg, Ca, Sr, Ba, or a combination thereof,
M comprises Sc, Y, Al, Gd, Lu, or a combination thereof, and
X comprises O, F, Cl, Br, I, or a combination thereof.

17. The blue light-emitting material according to claim 16, wherein the blue light-emitting material is represented by RbScF₄.
